(19) United States
(12) Patent Application Publication
(10) Pub. No.: US 2006/0078685 A1
(43) Pub. Date: Apr. 13, 2006

(54) Dust suppression method and apparatus

(76) Inventor: Graeme S. Frankpitt, (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/212,199

(22) Filed: Aug. 26, 2005

(30) Foreign Application Priority Data
Oct. 8, 2004 (AU) 2004905849

(51) Int. Cl. C08L 91/00; B05D 1/02

(52) U.S. Cl. 427/421.1; 106/269

(57) ABSTRACT

The present invention provides a process for suppressing dusting of dusting materials by spraying an aqueous dispersion of polytetrafluoroethylene (PTFE) or modified polytetrafluoroethylene onto the exposed exterior surfaces of the dusting material to fibrillate at least part of the dispersion and coat the exposed exterior surfaces of the dusting material with a web of fibrils of polytetrafluoroethylene or modified polytetrafluoroethylene. The process is especially advantageous for suppressing dusting of dusting materials contained in a pile, stockpile or open-topped container and dusting materials contained in open-topped transport vehicles.

### FIELD OF THE INVENTION

This invention relates to the suppression of dust deriving from dusting materials. Throughout the specification “dusting materials” is a term used to refer to material which contains a significant amount of dust, or, releases dust by virtue of movement thereof.

### BACKGROUND OF THE INVENTION

Dust derived from dusting materials, particularly pulverulent materials and powders, has been a long standing problem and continues to cause difficulties in handling such materials in industrial situations. Dust cannot only be a health hazard, from the point of view of ingesting the dust by breathing, but it can be a fire and explosion hazard as well.

The problems of dusting materials are most acute where toxic compounds or powders are readily dusted and that dust becomes highly toxic.

In such circumstances, solutions have been previously proposed which involve misting the space above the materials and/or also coating the materials, with water or oils, together with admixing compounds with the materials to reduce the amount of dust generated or released from the materials.

As will be readily understood, such methods are only applicable where the material being added to, or sprayed to dampen down, the material has no deleterious effect in further processing of that material. For instance, using a water misting system in relation to pigment powders, is of no use since the pigments are required to be dry when they are processed.

Other solutions to the dusting of materials, in the past, have included complex dust removal systems including vacuum systems, possibly leading to subsequent separation apparatus such as filters or precipitators for recovery of the dust. While these methods are useful in some areas, they are relatively expensive and do not suit open air storage or open air transport of dusting materials.

One particular instance of open air storage and transport of dusting materials, where the present invention has been found to be useful, is associated with the transportation of coal, iron ore or similar mined material in open-topped transport vehicles, such as rail wagons.

In a specific situation, there is a need in the coal industry, after mining of the coal, to ship the coal to a point of bulk transportation, such as a shipping terminal. The volume of coal handled in such operations is substantial.

The most efficient way currently employed to transfer coal from a mine to a shipping terminal is by means of rail, and one of the presently existing problems addressed by the present invention is the need for dust suppression during transportation of the coal by rail from the mining area to the ultimate shipping point.

### BRIEF SUMMARY OF THE INVENTION

The present invention provides a process for suppressing dusting of dusting materials by spraying an aqueous dispersion of polytetrafluoroethylene (PTFE) or modified polytetrafluoroethylene onto the exposed exterior surfaces of the dusting material to fibrillate at least part of the dispersion and coat the exposed external surfaces of the dusting material with a web of fibrils of polytetrafluoroethylene or modified polytetrafluoroethylene. The aqueous dispersion of polytetrafluoroethylene or modified polytetrafluoroethylene employed preferably has a polymer solids content of about 0.15 wt % to about 15 wt %. It is also preferred for the aqueous dispersion of polytetrafluoroethylene or modified polytetrafluoroethylene to contain about 2 wt % to about 11 wt % nonionic surfactant based on the weight of the polymer solids. Preferably, the aqueous dispersion contains aliphatic alcohol ethoxylate nonionic surfactant and is essentially free of surfactants containing aromatic groups. In a preferred process, the aqueous dispersion has a fluorosurfactant content of less than 30 ppm, preferably less than 10 ppm and most preferably less than 5 ppm. The process is especially advantageous for suppressing dusting of dusting materials contained in a pile, stockpile or open-topped container and dusting materials contained in open-topped transport vehicles.

### BRIEF DESCRIPTION OF THE DRAWING

FIG. 1 is a diagrammatical view of a process and associated apparatus in accordance with the invention for dust suppression treatment of the exposed exterior surface of coal contained in a rail car.

### DETAILED DESCRIPTION OF THE INVENTION

In an embodiment of the invention, it has been found that certain compositions containing polytetrafluoroethylene or modified polytetrafluoroethylene can be sprayed through an atomising nozzle under specified conditions, to cause the composition to fibrillate, and that spraying the atomised solution onto the exposed top surfaces of materials subject to dusting, such as coal contained in an open-topped container, for instance a rail wagon, or coal stockpiled in a shipping terminal stockyard, significantly suppresses the ability of the material to dust, including during transportation in such open-topped containers. The process is applicable to suppressing dust from any of a variety of dusting materials including coal and metal ore.

The fibrillated spray has been found to contain a web of sub-microscopic fibres of polytetrafluoroethylene or modified polytetrafluoroethylene, referred to as fibrils, which, when sprayed onto the exposed surface of said dusting material, form an interlocking web of fibrils which trap a substantial proportion of the dust in that web, while other particles of dust appear to adhere to the fibril web itself.

In another embodiment of the invention, there is provided a composition to be applied to the exposed surfaces of a load of dusting material contained in an open-topped container, which consists of a fibril web of polytetrafluoroethylene, resulting from atomisation and fibrillation of a dispersion thereof.

In yet another embodiment of the invention, there is provided a process of reducing or substantially eliminating dusting in a normally dusting material, which includes the step of spraying a dispersion of polytetrafluoroethylene or modified polytetrafluoroethylene through an atomising spray nozzle onto the exposed exterior surfaces of said normally dusting material, wherein at least part of said dispersion is fibrillated, whereby to coat the exposed external surfaces of said normally dusting material with a web of fibrils of polytetrafluoroethylene.

In accordance with a further embodiment of the invention, a concentrated dispersion of polytetrafluoroethylene or modified polytetrafluoroethylene, which is a hydrophobic negatively charged colloid, containing particles of between about 100 nm to about 500 nm in diameter and having a polymer solids content of typically about 30-70 wt % is diluted with water to low concentrations, below 20 parts per hundred by weight, preferably below 10 parts per hundred by weight, but, in excess of 0.5 parts per hundred by weight. Preferred diluted dispersions for use in accordance with the invention have a solids content of less than about 15 wt %, more preferably less than about 7.5 wt %, but, in excess of about 0.15 wt %. A particularly suitable working range for solids content is about 0.25 wt % to about 2.5 wt %. This dispersion is passed through an atomising spray nozzle having a diameter orifice of preferably between about 0.5 and about 2 millimetres under moderate pressure, which causes the dispersion to fibrillate and produce a fibril web.

Suitable pressures for atomising the emulsion are between about 100 kPa and about 1500 kPa.

Concentrated PTFE and modified PTFE dispersions for use in the present invention contain nonionic surfactants, preferably aliphatic alcohol ethoxylates, as will be explained in more detail hereinafter. The nonionic surfactants stabilize the concentrated dispersion and decrease its tendency to coagulate during manufacture and in subsequent handling. The nonionic surfactant is similarly beneficial in the diluted dispersions and assists with stabilizing the dispersion as is pumped and sprayed from the atomizing nozzle. When concentrated dispersions are diluted with water for use in accordance the with the invention, the level of nonionic surfactant based on polymer solids does not change. Thus, the nonionic surfactant in the diluted dispersion is at the same levels as in typical concentrated dispersions and preferably is about 2 wt % to about 11 wt % nonionic surfactant based on the weight of the polymer solids in the dispersion. If the concentrated dispersion does not contain the desired level of nonionic surfactant for use in this invention, additional nonionic surfactant can be added can be added to the diluted dispersion. As is also explained in more detail hereinafter, the dispersion is preferably free of nonionic surfactants containing aromatic groups.

As will be explained in more detail hereinafter, it is preferred to employ concentrated dispersions which contain substantially reduced levels of fluorosurfactants. After dilution for use in the present invention, the aqueous dispersion of polytetrafluorethylene or modified tetrafluoroethylene preferably has a fluorosurfactant content of less than about 30 ppm, more preferably less than about 10 ppm, and most preferably less than about 5 ppm.

As will be understood by the person skilled in the art, polytetrafluoroethylene possesses a high chemical and temperature resistance so that the risk of subsequent interaction with the treated material is considered to be low.

It should be noted that in accordance with the present invention it is not necessary for the atomised polytetrafluoroethylene dispersion to penetrate the exterior of the load of material in a container or stockpile. Rather, the forming of a web of fibrils on the exposed top surfaces of the material is sufficient to significantly suppress dusting of the material within the container or stockpile.

PTFE and Modified PTFE

Suitable dispersions employed in this invention are dispersions of non-melt-processible, fibrillating polytetrafluoroethylene (PTFE) including modified PTFE. Polytetrafluoroethylene (PTFE) refers to the polymerized tetrafluoroethylene by itself without any significant comonomer present. Modified PTFE refers to copolymers of TFE with such small concentrations of comonomer that the melting point of the resultant polymer is not substantially reduced below that of PTFE. The concentration of such comonomer is preferably less than 1 wt %, more preferably less than 0.5 wt %. The small amount of comonomer modifier improves film forming capability during baking (fusing) and can be as perfluoroolefin, notably hexafluoropropylene (HFP) or perfluoro(alkyl vinyl) ether (PAVE), where the alkyl group contains 1 to 5 carbon atoms, with perfluoro(ethyl vinyl) ether (PEVE) and perfluoro(propyl vinyl) ether (PPVE) being preferred. Chlorotrifluoroethylene (CTFE), perfluorobutyl ethylene (PFBE), or other monomer that introduces bulky side groups into the molecule are also possible comonomer modifiers. The PTFE or modified PTFE preferably has a melt creep viscosity of at least 1×10⁹Pa•s. The resins in the dispersion used in this invention when isolated and dried are non-melt-processible. Such high melt viscosity indicates that the PTFE or modified PTFE does not flow in the molten state and therefore is non-melt-processible.

By non-melt-processible, it is meant that no melt flow is detected when tested by the standard melt viscosity determining procedure for melt-processible polymers. This test is according to ASTM D-1238-00 modified as follows: The cylinder, orifice and piston tip are made of corrosion resistant alloy, Haynes Stellite 19, made by Haynes Stellite Co. The 5.0 g sample is charged to the 9.53 mm (0.375 inch) inside diameter cylinder which is maintained at 372° C. Five minutes after the sample is charged to the cylinder, it is extruded through a 2.10 mm (0.0825 inch diameter), 8.00 mm (0.315 inch) long square-edge orifice under a load (piston plus weight) of 5000 grams. This corresponds to a shear stress of 44.8 KPa (6.5 pounds per square inch). No melt extrudate is observed.

The PTFE and modified PTFE used in this invention preferably have a standard specific gravity (SSG) of less than 2.40, typically from about 2.14 to about 2.40, preferably less than about 2.30, and more preferably less than about 2.25. The SSG is generally inversely proportional to the molecular weight of PTFE or modified PTFE.

The fluoropolymer particles in the dispersion used in this invention preferably have a number average particle size of about 100 nm to about 500 nm, most preferably, about 140 nm to about 240 nm.

The fluoropolymer dispersion used in this invention is made by dispersion polymerization (also known as emulsion polymerization). A typical process for the aqueous dispersion polymerization of preferred polymer PTFE is a process wherein TFE vapor is fed to a heated reactor containing fluorosurfactants, paraffin wax and deionized water. A chain transfer agent may also be added if it is desired to reduce the molecular weight of the PTFE. A free-radical initiator solution is added and, as the polymerization proceeds, additional TFE is added to maintain the pressure. The exothermic heat of reaction is removed by circulating cooling water through the reactor jacket. After several hours, the feeds are stopped, the reactor is vented and purged with nitrogen, and the raw dispersion in the vessel is transferred to a cooling vessel. Paraffin wax is removed and the dispersion is isolated and stabilized with nonionic surfactant.

The dispersing agent used in this process is preferably a fluorinated surfactant. The fluorosurfactant in the dispersion is a non-telogenic, anionic dispersing agent, soluble in water and comprising an anionic hydrophilic group and a hydrophobic portion. Preferably, the hydrophobic portion is an aliphatic fluoroalkyl group containing at least four carbon atoms and bearing fluorine atoms and having no more than two carbon atoms not bearing fluorine atoms adjacent to the hydrophilic group. These fluorosurfactants are used as a polymerization aid for dispersing and, because they do not chain transfer, they do not cause formation of polymer with undesirable short chain length. An extensive list of suitable fluorosurfactants is disclosed in U.S. Pat. No. 2,559,752 to Berry. Preferably, the fluorosurfactant is a perfluorinated carboxylic or sulfonic acid having 6-10 carbon atoms and is typically used in salt form. Suitable fluorosurfactants are ammonium perfluorocarboxylates, e.g., ammonium perfluorocaprylate or ammonium perfluorooctanoate (APFO). The fluorosurfactants are usually present in the amount of 0.02 to 1 wt % with respect to the amount of polymer formed. The fluorinated surfactant is used to aid the polymerization process but the amount remaining in the concentrated dispersion composition to be used in the dust suppression process is preferably significantly reduced as will be explained below.

The initiators preferably used to make dispersion for use in the process of this invention are free radical initiators. They may be those having a relatively long half-life, preferably persulfates, e.g., ammonium persulfate or potassium persulfate. To shorten the half-life of persulfate initiators, reducing agents such as ammonium bisulfite or sodium metabisulfite, with or without metal catalysis salts such as Fe (III), can be used. Alternatively, short half-life initiators such as potassium permanganate/oxalic acid can be used.

In addition to the long half-life persulfate initiators, small amounts of short chain dicarboxylic acids such as succinic acid or initiators that produce succinic acid such as disuccinic acid peroxide (DSP) may be also be added in order to reduce coagulum.

To produce dispersion with low fluorosurfactant content as will be described below, sufficient nonionic surfactant is added to prevent coagulation of the dispersion when the fluorosurfactant content is reduced. Typically, nonionic surfactant is added for stabilization prior to fluorosurfactant reduction and then as desired, concentration of the dispersion is conducted. For concentrating, the polymer is held at a temperature above the cloud point of the nonionic surfactant. Once concentrated to about 30 to about 70 wt % fluoropolymer, and preferably about 45 to about 65 wt % fluoropolymer, the upper clear supernate is removed. Further adjustment of the final solids concentration and surfactant are made as needed. One patent illustrative of concentrating is U.S. Pat. No. 3,037,953 to Marks and Whipple.

Nonionic Surfactants

Nonionic surfactants preferably used in dispersions employed in accordance with the invention are aliphatic alcohol ethoxylates. They are preferably present in the concentrated dispersion and the diluted dispersion for use in the invention in amounts of about 2 to about 11 wt %, most preferably about 3 to about 11 wt %, based on the wt of the PTFE or modified PTFE. Suitable nonionic surfactants include any of a variety of aliphatic alcohol ethoxylates or mixtures thereof which provide the desired cloud point during concentration.

Further the dispersions used in this invention are preferably essentially free of surfactants containing aromatic groups that can thermally decompose and be converted to harmful organic aromatic compounds that may adversely affect air and water quality. Essentially free of surfactants containing aromatic groups preferably means that the dispersions employed contain less than about 0.5 wt % of such surfactants.

Especially preferred aliphatic alcohol ethoxylates are a compound or mixture of compounds of the formula:
R(OCH₂CH₂)ₙOH
wherein R is a branched alkyl, branched alkenyl, cycloalkyl, or cycloalkenyl hydrocarbon group having 8-18 carbon atoms and n is an average value of 5 to 18. For example, a preferred ethoxylate used in this invention can be considered to be prepared from (1) a primary alcohol that is comprised of a hydrocarbon group selected from branched alkyl, branched alkenyl, cycloalkyl or cycloalkenyl or (2) a secondary or tertiary alcohol. In any event, the ethoxylate used in accordance with this invention does not contain an aromatic group. The number of ethylene oxide units in the hydrophilic portion of the molecule may comprise either a broad or narrow monomodal distribution as typically supplied or a broader or bimodal distribution which may be obtained by blending.

The cloud point of a surfactant is a measure of the solubility of the surfactant in water. The surfactants employed in the aqueous dispersion of this invention preferably have a cloud point of about 30° C. to about 90° C., preferably about 35° C. to about 85° C.

Nonionic surfactants of the type generally used to stabilize fluoropolymer dispersions can be either liquids or solids at room temperature. If solid, the surfactant tends to be pasty and difficult to handle. They can be handled but often require heated tanks and transfer lines to keep them as a liquid. In addition to the capital cost of the heated equipment, there are operational restrictions placed on the system. If the temperature is maintained too low, tanks and transfer lines can become plugged with solid material. If the temperature is too high, degradation of the surfactant can occur.

Generally low viscosity liquids are preferred from a handling point of view. High viscosity liquids are more difficult to handle and often require heated tanks and lines to keep the viscosity low enough for ease in handling. Some of the apparent liquid surfactants are physically meta-stable in that they may exist as liquids for several days and then turn into pasty solids. Sometimes water is added to the surfactant to lower its viscosity and making it easier to handle. However, too much water detracts from the desire to produce more concentrated dispersions.

The aqueous dispersion of non-melt-processible PTFE or modified PTFE and nonionic surfactant used in this invention preferably contains a nonionic surfactant containing 0-20 wt % water, preferably 0-15 wt % water and is a stable liquid at room temperature. A surfactant is considered to be a stable liquid if it remains liquid for 3 days at room temperature after being chilled to 5° C. and then warmed to room temperature (about 23±3° C.).

Fluorosurfactant Reduction

The fluorosurfactant content of the concentrated aqueous dispersion of non-melt-processible PTFE or modified PTFE particles used in accordance with the present invention is preferably reduced to a predetermined level of less than about 300 ppm, more preferably to a predetermined level less than about 100 ppm, most preferably to a predetermined level less than about 50 ppm. Since the concentrated dispersion is diluted to preferably less than 20 parts per hundred by weight with water, the diluted dispersion will preferably contain even lower levels of fluorosurfactant, i.e, the previously stated preferred levels.

While any suitable method can be used to reduce fluorosurfactant content, contacting the aqueous dispersion with an anion exchange resin is advantageously used for this purpose. Contacting of the dispersion with anion exchange resin can occur before or after concentration but typically the lower solids material before concentration is easier to process, especially when a fixed bed is employed for carrying out the contacting step. If the process is carried out prior to concentration, nonionic surfactants as discussed above are added prior to contact with the anion exchange resin. Further, it is common to add a nonfluorinated anionic surfactant such as sodium lauryl sulfate to the dispersion prior to concentration (but after anion exchange) to prevent a viscosity increase which can occur upon concentration. A nonfluorinated cationic surfactant can also be used as described in U.S. Application No. 60/638,310, filed Dec. 22, 2004.

Any of a variety of techniques which bring the dispersion in contact with the anion exchange resin can be used to carry out ion exchange of the process. For example, the process can be carried out by addition of ion exchange resin beads to the dispersion in a stirred tank, in which a slurry of the dispersion and resin is formed, followed by separation of dispersion from the anion exchange resin beads by filtration. Another suitable method is to pass the dispersion through a fixed bed of anion exchange resin instead of using a stirred tank. Flow can be upward or downward through the bed and no separate separation step is needed since the resin remains in the fixed bed.

The contacting of the dispersion is performed at a temperature which is sufficiently high to facilitate the rate of ion exchange and to reduce the viscosity of the dispersion but being below a temperature at which the resin degrades at a detrimentally high rate or a viscosity increase in observed. Upper treatment temperature will vary with the type of polymer and nonionic surfactant employed. Typically, temperatures will be between 20° C. and 80° C.

The fluorosurfactant can be recovered from the anion exchange resin if desired or the resin with the fluorosurfactant can be disposed of in an environmentally acceptable method, e.g., by incineration. If it is desired to recover the fluorosurfactant, the fluorosurfactant may be removed from resin by elution. Elution of fluorosurfactant adsorbed on the anion exchange resin is readily achieved by use of ammonia solution as demonstrated by Seki in U.S. Pat. No. 3,882,153, by a mixture of dilute mineral acid with organic solvent (e.g., HCl/ethanol) as demonstrated by Kuhls in U.S. Pat. No. 4,282,162, or by strong mineral acids such as sulfuric acid and nitric, transferring the adsorbed fluorinated carboxylic acid to the eluent. The fluorosurfactant in the eluent in high concentration can easily be recovered in the form of a pure acid or in the form of salts by common methods such as acid-deposition, salting out, and other methods of concentration.

Ion Exchange Resins

The ion exchange resins for use in accordance with reducing the fluorosurfactant content of the aqueous dispersion used in the present invention include anionic resins but can also include other resin types such as cationic resins, e.g., in a mixed bed. The anionic resins employed can be either strongly basic or weakly basic. Suitable weakly basic anion exchange resins contain primary, secondary amine, or tertiary amine groups. Suitable strongly basic anion exchange resin contain quaternary ammonium groups. Although weakly basic resins are useful because they can be regenerated more easily, strongly basis resins are preferred when it is desired to reduce fluorosurfactant to very low levels and for high utilization of the resin. Strongly basic ion exchange resins also have the advantage of less sensitivity to the pH of the media. Strong base anion exchange resins have an associated counter ion and are typically available in chloride or hydroxide form but are readily converted to other forms if desired. Anion exchange resins with hydroxide, chloride, sulfate, and nitrate can be used for the removal of the fluorosurfactant but anion exchange resins in the form of hydroxide are preferred to prevent the introduction of additional anions and to increase pH during anion exchange because a high pH, i.e., greater than 9, is desirable in the product prior to shipping to inhibit bacterial growth. Examples of suitable commercially-available strong base anion exchange resins with quaternary ammonium groups with a trimethylamine moiety include DOWEX® 550A, US Filter A464-OH, SYBRON M-500-OH, SYBRON ASB1-OH, PUROLITE A-500-OH, Itochu TSA 1200, AMBERLITE® IR 402. Examples of suitable commercially-available strong base anion exchange resins with quaternary ammonium groups with a dimethyl ethanol amine moiety include US Filter A244-OH, AMBERLITE® 410, DOWEX® MARATHON A2, and DOWEX® UPCORE Mono A2.

Ion exchange resin used to reduce fluorosurfactant for use in the process of the present invention is preferably monodisperse. Preferably, the ion exchange resin beads have a number average size distribution in which 95% of the beads have a diameter within plus or minus 100 μm of the number average bead diameter.

The monodisperse ion exchange resin has a particle size which provides a suitable pressure drop through the bed. As discussed previously, very large beads are fragile and prone to breakage. Very small ion exchange beads are susceptible to tight particle packing resulting in tortuous channels in the bed. This can result in high shear conditions in the bed. Preferred ion exchange resin has a number average bead size about 450 to about 800 μm, more preferably, the ion exchange resin beads have a number average bead diameter of about 550 to about 700 μm.

### EXAMPLES

A particularly preferred embodiment of the invention, which should not be read to be limiting on the invention in any way, will now be described.

An open rail wagon containing a load of pulverulent coal, as mined, is subjected from above to an atomised spray of a diluted dispersion of polytetrafluoroethylene with reduced fluorosurfactant content sold under the designation TE-6002 by E.I. du Pont de Nemours and Company. The TE-6002 contains PTFE homopolymer (33.6 wt % solids), 3.9 wt % nonionic surfactant based on polymer solids (Tergitol® TMN-100X sold by Dow Chemical, Midland Mich.), and has an fluorosurfactant (APFO) content of 25 ppm based on the weight of the dispersion. The TE-6002 dispersion is diluted with water at a concentration rate of 5 parts dispersion per hundred by weight water (˜1.7 wt % PTFE in diluted dispersion). The atomising spray nozzle of the apparatus of the invention is provided with the diluted water dispersion of TE-6002 under a pressure of 700 kPa, which causes the dispersion to fibrillate upon atomisation. The resulting spray is directed downwardly at the top of the load of pulverulent coal in the rail wagon, and settles on the exposed surfaces of the coal at the top of the load. The atomised spray is a mixture of sub-microscopic fibres of the TE-6002 polytetrafluoroethylene which form a web. The sub-microscopic fibres are referred to as fibrils and have a thickness of approximately 100 Angstrom. The web formed is such that the majority of particles of dust within the load of coal remain trapped by, or in, the web of fibrils, as if caged. It is also observed that other particles of dust from within the load of coal adhere to the web itself. When dispersion is applied and upon drying for anywhere from 5 to 60 minutes, it is observed that the fibrillated web over the coal turns a blue-grey color providing a visual indication that a pile has been treated by this process. Such color lasts until the coal is moved or until subjected to rain.

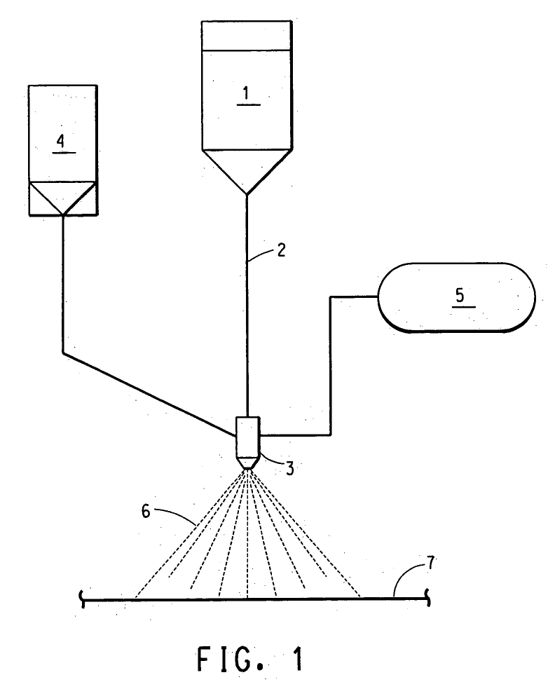

A second particularly preferred embodiment of the invention, which may also not be read as limiting on the invention, will be described with reference to FIG. 1 of the accompanying drawing.

A load of coal, the top surface of which is shown at 7, is positioned beneath an atomising nozzle 3.

Connected to nozzle 3 is a supply of TE-6002 polytetrafluoroethylene dispersion diluted in water in vessel 1, which is supplied to nozzle 3 under pressure, through line 2. Also connected to nozzle 3 is a supply of concentrated TE-6002 polytetrafluoroethylene dispersion in vessel 4, which is supplied to nozzle 3 at a pre-set rate.

When it is desired to form a fog of fibrillated polytetrafluoroethylene, to reduce dust forming a cloud for instance, pressurised air in vessel 5 can also be provided to nozzle 3, so that the highly atomised polytetrafluoroethylene issues as a fog, to suppress airborne dust above coal surface 7.

Where pressurised air is not provided to nozzle 3, the atomised fibrillated polytetrafluoroethylene issues as a spray 6 on to the exposed surface of coal 7.

It will be understood by people skilled in the art, that dispersions of polytetrafluoroethylene which have similar properties to TE-6002, may also be employed in the invention.

Following application of the spray, substantial dust suppression occurs in relation to a load of coal. Tests conducted in relation to the amount of dusting currently expected from loads of coal show that the web of fibrils produced in accordance with the invention was between 5 and 10 times more effective in coal dust suppression, than the currently available chemical treatments for dust suppression for such loads. The tests were conducted in respect of three Australian coal types, these being coals classified as low dusting, medium dusting and high dusting.

It has also been shown that even under severe conditions of approximately 28° C. and wind speeds above 8 to 10 meters/sec, the dust suppression process of the present invention is more effective than frequent application (every one to 4 hours) of water spray. The present process is therefore able to use from 10 to 20 times less water thereby conserving the use of water which is of concern in many locations throughout the world and greatly reducing time spent for treatment.

As exemplified above, the invention also includes production of a fog of highly atomised polytetrafluoroethylene emulsion which can be sprayed directly onto a cloud of dust already in existence, whereby to settle that cloud of dust and clarify the air above the dust producing material. It is believed that similar mechanical entrapment and adhesion forces result in the suppression of the dust cloud.

In accordance with the invention, the fibrillated atomised spray can also be applied to dusting materials stock piled in bins, or simply piled together in stock piles, by spraying the external surface of the pile or stock pile.

A number of polytetrafluoroethylene containing compositions are effective in the present invention, and the determining factor for their effectiveness, is whether and to what extent they fibrillate to produce the web of fibrils under atomising conditions. Examples of other polytetrafluoroethylene polymers in addition to TE-6002 which may be used to make effective polytetrafluoroethylene emulsions for the invention are known in the art. Additional low APFO dispersions commercially available from E.I. du Pont de Nemours and Company include those designated TE-3859, TE-3865, TE-3870, TE-3873, TE-3879 and TE-3893. Fluoropolymer solids levels vary in these dispersions from TE-6002 and dilution rates will need to be adjusted appropriately.

Polytetrafluoroethylene containing dispersions which cannot be made to fibrillate do not form part of the present invention.

Since modifications within the spirit and scope of the invention may be readily effected by persons skilled in the art, it is to be understood that the invention is not limited to the particular embodiment described, by way of example, hereinabove.

What is claimed is:

1. A process for suppressing dusting of dusting materials comprising spraying an aqueous dispersion of polytetrafluoroethylene or modified polytetrafluoroethylene onto the exposed exterior surfaces of said dusting material to fibrillate at least part of said dispersion and coat the exposed exterior surfaces of said dusting material with a web of fibrils of polytetrafluoroethylene or modified polytetrafluoroethylene.

2. The process of claim 1 wherein said aqueous dispersion of polytetrafluoroethylene or modified polytetrafluoroethylene has a polymer solids content of about 0.15 wt % to about 15 wt %.

3. The process of claim 1 wherein said aqueous dispersion of polytetrafluoroethylene or modified polytetrafluoroethylene contains about 2 wt % to about 11 wt % nonionic surfactant based on the weight of the polymer solids.

4. The process of claim 1 wherein said dispersion comprises an aliphatic alcohol ethoxylate nonionic surfactant and is essentially free of surfactants containing aromatic groups.

5. The process of claim 1 wherein said dispersion comprises polytetrafluoroethylene or modified polytetrafluoroethylene having an SSG of less than about 2.40.

6. The process of claim 1 wherein said spraying is performed using an atomising spray nozzle.

7. The process of claim 1 wherein said dusting material is contained in a pile, a stockpile, or open-topped container.

8. The process of claim 1 wherein said dusting material is in an open-topped transport vehicle.

9. The process of claim 8 wherein said open-topped transport vehicle is a rail wagon.

10. The process of claim 1 wherein said dusting material is selected from the group consisting of coal and metal ore.

11. A process for suppressing an existing clould of dust above a dusting material comprising spraying a fog of highly atomised aqueous dispersion of polytetrafluoroethylene or modified polytetrafluoroethylene onto the cloud of dust whereby the cloud of dust is at least partially settled.
